(19) United States
(12) Patent Application Publication
(10) Pub. No.: US 2026/0127537 A1
(43) Pub. Date: May 7, 2026

(54) DATA-DRIVEN PRIORITIZED CUSTOMER RETENTION

(71) Applicant: Kyndryl, Inc., New York, NY (US)

(72) Inventors: Gail Camille Guerrero, Austin, TX (US); Geetha R. Subramanyam, Nagari (IN); Omar Odibat, Cedar Park, TX (US); Preethi Ravishankar Sulkunte, Bengaluru (IN); Viswanatha Krishnamurthy, Bengaluru (IN)

(21) Appl. No.: 18/937,636

(22) Filed: Nov. 5, 2024

(51) Int. Cl. G06Q 10/0639; G06Q 10/0635

(52) U.S. Cl. CPC G06Q 10/06393; G06Q 10/0635

(57) ABSTRACT

A computer-implemented method that receives a plurality of customer content and calculates a sentiment score and a weightage score for at least a subset of the plurality of customer content. The method may further include generating a customer score for one or more factors of a set of factors affecting customer satisfaction based on the sentiment score and the weightage score for at least the subset of the plurality of customer content. In embodiments, the method further determines an attrition risk score and a first ranked set of recommended action items for the one or more factors of the set of factors affecting customer satisfaction and notifies user of the attrition risk score and the first ranked set of recommended action items to be executed. The method may further perform a first action of the first ranked set of recommended action items.

### BACKGROUND

Aspects of the present invention relate generally to determining attrition risk for customers of cloud resource management services and determining the root cause for customer attrition.

Customer attrition is the loss of clients or customers and an indicator of whether the company is performing well and providing value to customers.

### SUMMARY

In a first aspect of the present invention, there is a computer-implemented method including: receiving, by a processor set, a plurality of customer content; calculating, by the processor set using a first machine learning algorithm, a sentiment score and a weightage score for at least a subset of the plurality of customer content; generating, by the processor set using a second machine learning algorithm, a customer score for one or more factors of a set of factors affecting customer satisfaction based on the sentiment score and the weightage score for at least the subset of the plurality of customer content; determining, by the processor set using a third machine learning algorithm, an attrition risk score and a first ranked set of recommended action items for the one or more factors of the set of factors affecting customer satisfaction; notifying a user of the attrition risk score and the first ranked set of recommended action items to be executed; and performing, by the processor, a first action of the first ranked set of recommended action items.

In another aspect of the present invention, there is a computer program product including one or more computer readable storage media having program instructions collectively stored on the one or more computer readable storage media. The program instructions are executable to: receive a plurality of customer content; calculate, using a first machine learning algorithm, a sentiment score and a weightage score for at least a subset of the plurality of customer content; generate, using a second machine learning algorithm, a customer score for one or more factors of a set of factors affecting customer satisfaction based on the sentiment score and the weightage score for at least the subset of the plurality of customer content; determine, using a third machine learning algorithm, an attrition risk score and a first ranked set of recommended action items for the one or more factors of the set of factors affecting customer satisfaction; notify a user of the attrition risk score and the first ranked set of recommended action items to be executed; and perform a first action of the first ranked set of recommended action items.

In another aspect of the present invention, there is a system including a processor, a computer readable memory, one or more computer readable storage media, and program instructions collectively stored on the one or more computer readable storage media. The program instructions are executable to: receive a plurality of customer content; calculate, using a first machine learning algorithm, a sentiment score and a weightage score for at least a subset of the plurality of customer content; generate, using a second machine learning algorithm, a customer score for one or more factors of a set of factors affecting customer satisfaction based on the sentiment score and the weightage score for at least the subset of the plurality of customer content; determine, using a third machine learning algorithm, an attrition risk score and a first ranked set of recommended action items for the one or more factors of the set of factors affecting customer satisfaction; notify a user of the attrition risk score and the first ranked set of recommended action items to be executed; and perform a first action of the first ranked set of recommended action items.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the present invention.

FIG. 5 shows a flowchart of an exemplary method in accordance with aspects of the present invention.

FIG. 6 shows an exemplary flow diagram of an exemplary method in accordance with aspects of the present invention.

FIG. 7 shows an exemplary flow diagram of an exemplary method in accordance with aspects of the present invention.

FIG. 8 shows an exemplary dashboard display of an exemplary embodiment in accordance with aspects of the present invention.

### DETAILED DESCRIPTION

Aspects of the present invention relate generally to determining attrition risk for customers of cloud resource management services and determining the root cause for customer attrition and, more particularly, to ranking top action items to retain customers. According to aspects of the present invention, the system, method, and computer program product may be generally configured to provide a single platform for determining customer content, determining a set of factors affecting customer satisfaction. The system, method, and computer program product may further determine an attrition risk score and/or a ranked set of recommended action items for the one or more factors of the set of factors affecting customer satisfaction based on calculated customer scores, sentiment scores, and weightage scores. The systems, methods, and computer program products described herein predict customer attrition risk in cloud resource management services and proactively address issues that may lead to customer churn and improve overall customer retention strategies.

According to an aspect of the present invention, there is a computer-implemented method for evaluating operational maturity, the computer-implemented method including: determining, from a set of customer content, a set of factors affecting customer satisfaction; calculating a sentiment score and a weightage score for at least a subset of the set of factors affecting customer satisfaction; classifying the subset of the set of factors affecting customer satisfaction into a set of key performance indicators (KPI); generating, from the sentiment scores and the weightage scores, a KPI score for at least a subset of the KPI; (determining, from the KPI scores, the set of customer content, and the sentiment scores and weightage scores, an attrition risk score and a ranked set of recommended action items for at least the subset of the KPI; in response to a triggering event, recording a customer score state and a set of action items executed; and notifying a user of the customer score state and the set of action items executed.

According to an aspect of the present invention the foregoing computer-implemented method may also include, in response to determining one or more KPI scores and/or the attrition score exceeds a threshold, performing a root cause analysis based on the customer score state; and recommending a second set of recommended action items, the second set based on the root cause analysis and historical recommendations for the customer and a set of effective action items performed for a set of third-party customers.

According to an aspect of the present invention the foregoing trigger event may include a predetermined interval and/or a determination that at least one of the ranked set of recommendation action items has been executed. According to an aspect of the present invention the foregoing set of customer content may include customer communications, multimedia data, news data, social media data, demographics data, financial operations (FinOps) data, platform analytics, development operations (DevOps) data, and historical recommendations. According to an aspect of the present invention the foregoing customer score state may include the sentiment scores, weightage scores, KPI scores, and the attrition risk score.

Customer attrition, also known as customer churn, is the loss of clients or customers over time and serves as a critical indicator of a company's performance and its ability to deliver value to its customers. Retaining existing customers is generally more profitable than acquiring new ones due to several factors, including lower acquisition costs, increased customer lifetime value through a higher volume of service consumption, and the potential for customer referrals that bring in new business organically. Therefore, understanding and mitigating the reasons behind customer dissatisfaction are essential for maintaining a stable customer base and ensuring long-term profitability.

In the context of cloud resource management services, where customer satisfaction is crucial for retaining clients, there is a significant gap in conventional solutions. Currently, in conventional systems, there is no comprehensive method for effectively evaluating customer satisfaction levels in cloud resource management services. Further conventional cloud resource management services do not generate prioritized lists of actions that an enterprise should take to retain customers who are at risk of churning. This lack of a targeted solution within conventional systems makes it challenging for companies to proactively address potential issues and tailor their retention strategies to individual customer needs. Consequently, the present invention develops effective cloud resource management services systems, methods, and computer program products to assess customer satisfaction and identify at-risk customers that could provide substantial financial benefits by reducing churn rates and fostering stronger customer loyalty in the competitive landscape of cloud services.

Embodiments and aspects of the present invention provide a system, method, and computer program product that improves and advances the technology in a specific and practical application. In other words, embodiments and aspects of the present invention improve the field of cloud resource management. In other words, embodiments and aspects of the present invention provide systems, methods, and computer program products for effectively evaluating customer satisfaction levels and generating a prioritized list of actions to retain customers who are at risk of churning. The present invention assesses customer satisfaction, identifies at-risk customers using a data driven approach, and provides substantial benefits by reducing churn rates and fostering stronger customer loyalty in the competitive landscape of cloud services. Furthermore, the embodiments and aspects of the present invention provide a more efficient, more robust, and cost-effective solution.

Implementations of the present invention are necessarily rooted in computer technology. For example, at least the steps of calculating, using a first machine learning algorithm, a sentiment score and a weightage score for at least a subset of the set plurality of customer content; generating, using a second machine learning algorithm, a customer score for one or more factors of a set of factors affecting customer satisfaction based on the sentiment score and the weightage score for at least the subset of the plurality of customer content; determining, using a third machine learning algorithm, an attrition risk score and a first ranked set of recommended action items for the one or more factors of the set of factors affecting customer satisfaction; and performing a first action of the first ranked set of recommended action items, are computer-based, are individually and collectively very complex, and cannot be performed in the human mind. Given the scale and complexity required to perform the foregoing tasks, it is simply not possible for the human mind, or for a person using pen and paper, to perform the number of calculations involved in performing a generative artificial intelligence (AI) algorithm (e.g., GPT 3.5), a natural language processing algorithm (e.g., TextRank), a transformer model (e.g., GPT-4®), a neural network algorithm (e.g., DeepMind® Perceiver), a survival analysis algorithm (e.g., Cox Proportional Hazards model or XGBoost), a SHapley Additive exPlanations (SHAPE) algorithm, a Local Interpretable Model-agnostic Explanations (LIME) algorithm, and/or other algorithms, machine learning (ML), and AI algorithms known by one of ordinary skill in the art.

Furthermore, using a machine learning (ML) model is, by definition, performed by a computer and cannot practically be performed in the human mind (or with pen and paper) due to the complexity and massive amounts of calculations involved. Given this scale and complexity, it is simply not possible for the human mind, or for a person using pen and paper, to perform the number of calculations involved in using the machine learning models provided above. For example, the ML models are trained using vast amounts of customer content including one or more of customer demographics (e.g., industry, region, size, revenue, new status, legacy status, age of service, and more), financial operations (FinOps) data (e.g., cost/spend, budget, asset details, asset utilization metrics, maturity rating, and more), platform analytics data (e.g., bounce rate, login frequency, time spent on platform, cookies, interaction with competitors, etc.), development operations (DevOps) (e.g., software, bugs, feature requests, support tickets, and more), internal and external delivery statistics (e.g., delivery evaluations, customer feedback, meeting transcripts, meeting recordings, emails, written communications, cookies, interaction with competitors, interaction with the customer, etc.), historical recommendations (e.g., previous recommendations taken, customer response, etc.), and/or any other collected data that may provide insight into the data of the customer. The customer content is normalized, and the normalized customer content is analyzed and/or measured against historical data to determine factors and weights to assign to the customer content. Using this data, ML models (e.g., generative AI algorithms, natural language processing algorithms, transformer models, neural network algorithms, survival analysis algorithms, SHapley Additive exPlanations (SHAPE) algorithms, Local Interpretable Model-agnostic Explanations (LIME) algorithms) are trained to determine the likelihood that a customer will leave a cloud service platform.

It should be understood that, to the extent implementations of the present invention collect, store, or employ personal information provided by, or obtained from, individuals (for example, any customer content and/or customer data that may include personal information, personal communications, personal preferences, identifying information, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

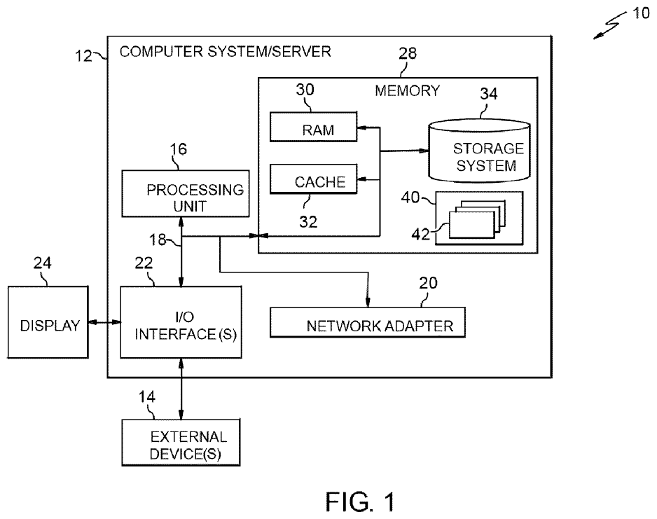

Referring now to FIG. 1, a schematic of an example of a cloud computing node is shown. Cloud computing node 10 is only one example of a suitable cloud computing node and is not intended to suggest any limitation as to the scope of use or functionality of embodiments of the present invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the present invention as described herein.

Computer system/server 12 may also communicate with one or more external devices 14 such as a keyboard, a pointing device, a display 24, etc. ; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to microcode, device drivers, redundant processing units, external disk drive arrays, RAID systems, tape drives, and data archival storage systems, etc.

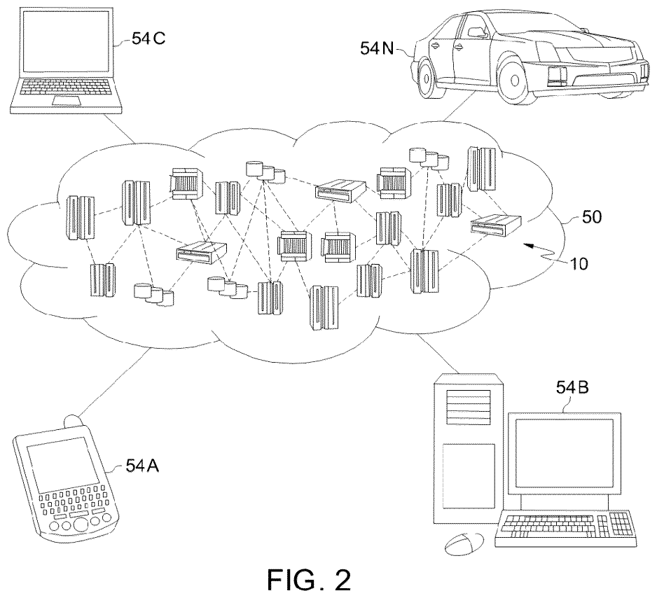

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

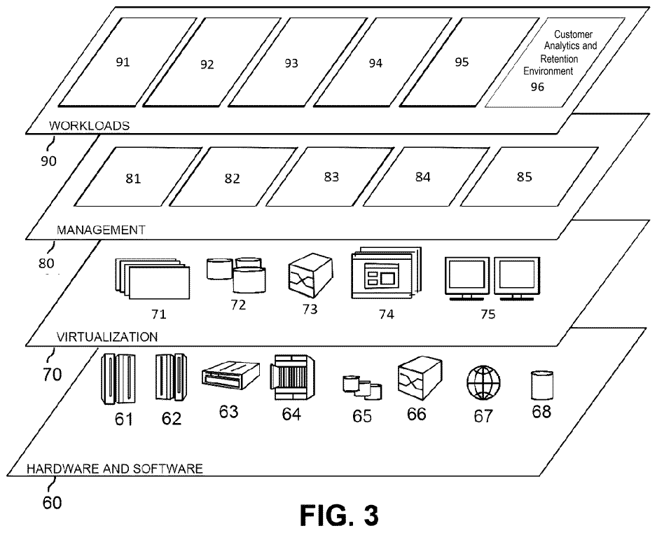

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the present invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and customer analytics and retention environment 96.

Implementations of the present invention may include a computer system/server 12 of FIG. 1 in which one or more of the program modules 42 are configured to perform (or cause the computer system/server 12 to perform) one of more functions of customer analytics and retention environment 96 of FIG. 3. For example, the one or more of the program modules 42 may be configured to: receive a plurality of customer content; calculate, using a first machine learning algorithm, a sentiment score and a weightage score for at least a subset of the plurality of customer content; generate, using a second machine learning algorithm, a customer score for one or more factors of a set of factors affecting customer satisfaction based on the sentiment score and the weightage score for at least the subset of the plurality of customer content; determine, using a third machine learning algorithm, an attrition risk score and a first ranked set of recommended action items for the one or more factors of the set of factors affecting customer satisfaction; notify a user of the attrition risk score and the first ranked set of recommended action items to be executed; and perform a first action of the first ranked set of recommended action items.

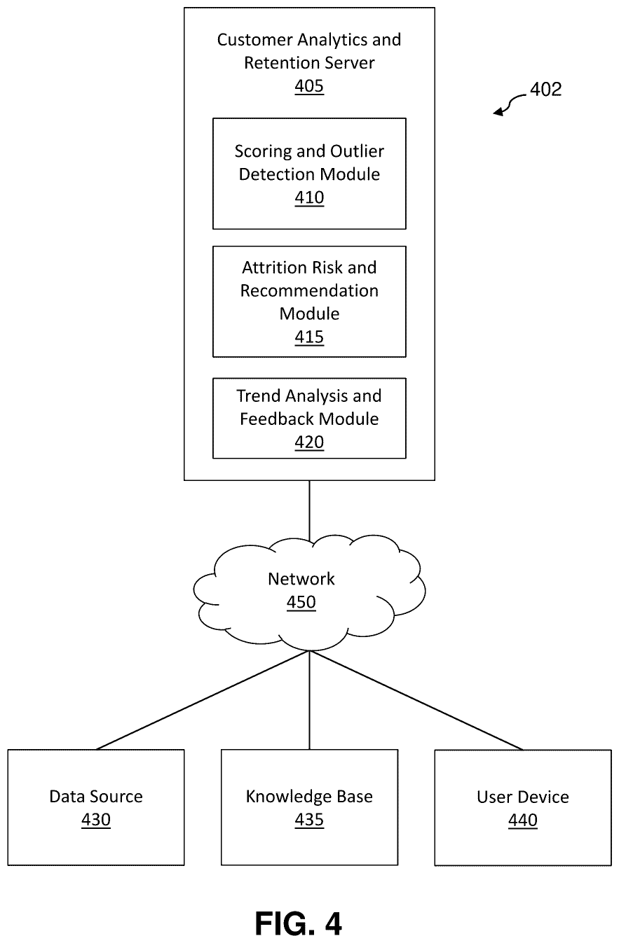

FIG. 4 shows a block diagram of exemplary environment 402 in accordance with aspects of the present invention. In embodiments, the environment 402 includes a customer analytics and retention server 405, data source 430, a knowledge base 435, user device 440, and a network 450.

Customer analytics and retention server 405 may comprise one or more instances of computer system/server 12 of FIG. 1. In another example, customer analytics and retention server 405 may comprise one or more virtual machines or containers running on one or more instances of computer system/server 12 of FIG. 1. In embodiments, customer analytics and retention server 405 communicates with data source 430, knowledge base 435, and user device 440 via network 450, which may comprise cloud computing environment 50 of FIG. 2. In embodiments, data source 430 comprises one or more instances of hardware and software components of hardware and software layer 60 of FIG. 3. In embodiments, knowledge base 235 comprises one or more instances of hardware and software components of hardware and software layer 60 of FIG. 3. In embodiments, user device 440 comprises an instance of an end user device such as, for example, personal digital assistant (PDA) or cellular telephone 54A, desktop computer 54B, laptop computer 54C, and/or automobile computer system 54N of FIG. 2. In embodiments, there may be plural different instances of user device 440. The different instances of user device 440 may be used by different users, product managers, system administrators, and/or other users that may access customer analytics and retention server 405, respectively.

In embodiments, customer analytics and retention server 405 comprises a scoring and outlier detection module 410, an attrition risk and recommendation module 415, and a trend analysis and feedback module 420, each of which may comprise one or more program modules such as program modules 42 described with respect to FIG. 1. Customer analytics and retention server 405 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments, customer analytics and retention server 405 is configured to receive, access, or obtain a plurality (e.g., a set) of customer content. As used herein, customer content may include one or more of customer demographics (e.g., industry, region, size, revenue, new status, legacy status, age of service, and more), financial operations (FinOps) data (e.g., cost/spend, budget, asset details, asset utilization metrics, maturity rating, and more), platform analytics data (e.g., bounce rate, login frequency, time spent on platform, cookies, interaction with competitors, etc.), development operations (DevOps) (e.g., software, bugs, feature requests, support tickets, and more), internal and external delivery statistics (e.g., delivery evaluations, customer feedback, meeting transcripts, meeting recordings, emails, written communications, cookies, interaction with competitors, interaction with the customer, etc.), historical recommendations (e.g., previous recommendations taken, customer response, etc.), and/or any other collected data that may provide insight into the data of the customer. In embodiments, customer analytics and retention server 405 receives, accesses, or obtains the customer content at or from the data source 430, the knowledge base 435, and/or the user device 440 over network 450.

In embodiments, customer analytics and retention server 405 is configured to perform feature engineering on the customer content. As used herein, feature engineering comprises data pre-processing techniques to extract relevant fields for at least one of several different scores, including a communications engagement score, platform interaction score, service adoption score, state and/or maturity of the cloud environment, cloud spend and utilization, etc. In embodiments, feature engineering may include normalizing data, filtering data to obtain a subset of analytics data, cleaning the data so the data meets formatting requirements of the scoring methods, creating new features from raw data, and/or other methods for pre-processing data to be used in a data scoring model. For example, the feature engineering may include data pre-processing, where the raw data is transformed into new features by normalizing numerical values, encoding categorical variables, and/or deriving new features based on domain knowledge to better capture underlying patterns. In embodiments, normalizing numerical values refers adjusting the values of numerical data to fit within a certain range of values to ensure that all variables contribute equally to models like machine learning algorithms, where features with larger scales can disproportionately influence the results. In such embodiments, normalizing numerical values may be completed using techniques such as rescaling, z-score normalization, decimal scaling, log transformation, etc. In embodiments, encoding categorical variables refers to converting categorical data (e.g., non-numeric, qualitative data) into a numerical format so that machine learning algorithms can use it effectively. In such embodiments, encoding categorical variables may be completed using techniques such as label encoding, one-hot encoding, binary encoding, frequency encoding, etc. In embodiments, deriving new features based on domain knowledge to better capture underlying patterns refers to creating new variables (i.e., features) that represent the underlying patterns in the data. In such embodiments, domain knowledge allows the present system, method, computer program product to understand the context of the data and extract insights by combining, transforming, or aggregating existing features. The foregoing feature engineering helps in creating a more suitable input for scoring models and enhance their predictive accuracy and performance.

In embodiments, scoring and outlier detection module 410 is further configured to determine factors that affect customer satisfaction. In such embodiments, scoring and outlier detection module 410 receives a summary of text (e.g., emails, meeting transcripts, service documentation, correspondence, and/or other records of communication with customers), tickets (e.g., service request tickets, feature request tickets, and/or bugs/issues reported), recordings, video, and/or other soft data into an AI machine learning (ML) algorithm trained to generate a summarization of factors affecting customer satisfaction. As used herein, soft data refers to qualitative information that is subjective, descriptive, and/or otherwise not easily measurable in numerical terms. In embodiments, scoring and outlier detection module 410 may determine or select a specific ML algorithm or ML algorithms based on the customer content. For example, in embodiments, the ML algorithm(s) selected for summarizing textual data may include a generative AI algorithm (e.g., GPT 3.5) and/or a natural language processing algorithm (e.g., TextRank). If the customer content includes video data, the selected ML algorithm may further (or alternatively) include a transformer model (e.g., GPT-4®) or neural network algorithm (e.g., DeepMind® Perceiver) for summarizing video recordings and textual data. In embodiments having video and audio data, the selected model(s) may first transcribe the audio/video data to text and then summarize textual data, as described above. In such embodiments, the ML algorithm may further provide evidence documents to support the summarization of factors affecting customer satisfaction. For example, scoring and outlier detection module 410 may provide an email, a service ticket, and other evidence to support the summarization of factors affecting customer satisfaction generated by the ML algorithm.

In accordance with aspects of the present invention, scoring and outlier detection module 410 is configured to calculate a sentiment score and a weightage score for at least a subset of the plurality of customer content. The sentiment score is calculated by scoring and outlier detection module 410 by measuring key performance indicators (KPIs) or other factors, including emotional tone or attitude expressed in customer feedback, reviews, or interactions, and assigning a value based on a combination of the KPIs and/or other factors. In further embodiments, the sentiment score quantifies whether the sentiment conveyed is positive, negative, or neutral and provides insights into customer satisfaction and engagement. The sentiment score helps gauge overall customer satisfaction by analyzing written correspondence (e.g., emails, meeting transcripts, service documentation, correspondence, and/or other records of communication with customers) and/or tickets (e.g., service request tickets, feature request tickets, and/or bugs/issues reported). In embodiments, the scoring and outlier detection module 410 analyzes the written correspondence using ML algorithms including a generative AI algorithm (e.g., GPT 3.5), a natural language processing algorithm (e.g., TextRank), a transformer model (e.g., GPT-4®), and/or neural network algorithm (e.g., DeepMind® Perceiver). A higher relative sentiment score indicates satisfaction, while relatively lower sentiment scores indicate dissatisfaction. By monitoring sentiment scores over time and comparing the sentiment scores against historical sentiment scores, businesses can identify trends and/or early warning signs of potential churn.

As used herein, the weightage score is calculated by scoring and outlier detection module 410 by measuring the relative importance or influence of various KPIs or factors contributing to a likelihood that a customer may stay or leave and assigning a value based on a combination of KPIs and/or factors. The weightage score assigns numerical values to different KPIs or factors (e.g., type of customer feedback, strength of customer feedback, transaction history, engagement levels, and/or any other KPIs or factors that indicate a level of intent or seriousness with respect to a specific issue) based on their influence on retention or churn. A higher relative weightage score indicates a stronger impact on the likelihood of retention or churn, while a relatively lower weightage score indicates a lower impact on the likelihood of retention or churn. In other words, the ML algorithms (e.g., generative AI algorithm, natural language processing algorithm, transformer model, and/or neural network algorithm) consider the foregoing features and their corresponding weightages to make accurate predictions about future customer behavior. By calculating weightage scores, interventions and resources are more effective and more efficient. For instance, if the weightage score for customer service quality is relatively high, more emphasis might be placed on improving customer service quality and standards.

In embodiments, scoring and outlier detection module 410 is further (or alternatively) configured to calculate and/or generate a customer score for one or more factors affecting customer satisfaction. As used herein, the customer score refers to the customer's level of use, interaction, integration, application, etc., with the cloud service. For example, when a customer frequently interacts with the cloud service, the high frequency of interaction increases the overall customer score. Alternatively, if the customer does not interact, or rarely interacts, with the cloud service, the infrequent interaction reduces the overall customer score. In embodiments, the customer score is determined based, at least in part, on one or more sentiment scores and one or more weightage scores. In embodiments, the customer score is additionally (or alternatively) determined using one or more of a communications engagement score, platform interaction score, service adoption score, state and/or maturity of the cloud environment, cloud spend and utilization, and/or other scoring methods that measure a level of customer satisfaction, level of engagement, and/or level of understanding of the services they are using.

In embodiments, scoring and outlier detection module 410 is further configured to detect data outliers. In other words, scoring and outlier detection module 410 may use statistical methods such as a z-score method, interquartile range, and/or any other statistical method for detecting outlier data to identify unusual negative or positive changes in sentiment and/or any of the factors that indicate a customer sentiment. When the scoring and outlier detection module 410 detects outlier data, customer analytics and retention server 405 may generate a notification and/or alert based on the outlier data (e.g., unusual negative or positive changes in sentiment and/or any of the factors that indicate a customer sentiment).

In embodiments, attrition risk and recommendation module 415 is configured to receive one or more customer scores and the summarization(s) of factors affecting customer satisfaction (e.g., one or more sentiment scores and/or one or more weightage scores) from scoring and outlier detection module 410. The attrition risk and recommendation module 415 determines and/or assigns an attrition risk score based on the received customer scores and the summarization(s) of factors affecting customer satisfaction. As used herein, an attrition risk score measures the likelihood or probability that a customer will remain a customer. In other words, the attrition risk score quantifies the risk of customer churn based on various factors affecting customer satisfaction and engagement. The attrition risk score helps identify high-risk customers who may need targeted action items (e.g., retention strategies or personalized offers) to improve their satisfaction and prevent churn. In embodiments, the attrition risk and recommendation module 415 determines and/or assigns an attrition risk score using a ML algorithm such as a survival analysis algorithm (e.g., Cox Proportional Hazards model or XGBoost) trained to analyze and predict an amount of time until customer churn might occur and assigns an attrition risk score based on the prediction. Attrition risk and recommendation module 415 may additionally (or alternatively) use SHapley Additive exPlanations (SHAPE) algorithm and/or Local Interpretable Model-agnostic Explanations (LIME) algorithm to identify which factors contribute the most to attrition risk and assign an attrition risk score based on the identified factors.

In embodiments, attrition risk and recommendation module 415 is configured to generate recommended action items for one or more of the factors affecting customer satisfaction. As used herein, action items refer to specific, targeted interventions or strategies designed to address the factors affecting customer satisfaction. These action items aim to improve customer experience, reduce their risk of leaving, and enhance overall retention. For example, possible action items may include: retention strategies (e.g., discounts, providing additional support, and/or creating tailored engagement plans), personalized offers (e.g., tailored promotions and/or incentives based on the customer's preferences and behaviors, designed to increase their satisfaction and loyalty), service improvements (e.g., changes or enhancements in service quality, responsiveness, and/or product features that address specific issues or concerns raised by customers), customer engagement initiatives (e.g., activities to increase customer interaction and engagement), targeted communications (e.g., tailored messages or outreach to address specific issues, provide solutions, and/or acknowledge customer feedback), etc.

In aspects of the present invention, attrition risk and recommendation module 415 may generate action items for each of the one or more of the factors affecting customer satisfaction. In other embodiments, action items are only generated for one or more factors that cause the risk score to exceed (or alternatively falls below) a predetermined threshold. For example, in response to a customer's cloud spend/utilization being considered “normal” compared with respect to peers the cloud spend/utilization and being determined to have a relatively low impact on customer churn, the risk score may be relatively low and attrition risk and recommendation module 415 will not generate any action items. In other embodiments, attrition risk and recommendation module 415 may generate action items to improve factors related to relatively low risk scores. For example, even though a customer's cloud spend/utilization being considered “normal” compared with respect to peers the cloud spend/utilization being determined to have a relatively low impact on customer churn, attrition risk and recommendation module 415 may still generate action items to improve the customer's cloud spend/utilization. In other embodiments, because the cloud spend/utilization is associated with a relatively low risk score, attrition risk and recommendation module 415 would not generate any action items.

In embodiments, attrition risk and recommendation module 415 is configured to rank the recommended action items based on the action's impact on customer satisfaction, including, the customer score and the summarization(s) of factors affecting customer satisfaction (e.g., one or more sentiment scores and/or one or more weightage scores). In other words, a higher ranked action item means that the action item has a greater impact on a customer's satisfaction as compared to a lower ranked action item that has a lesser impact on a customer's satisfaction. For example, in response to attrition risk and recommendation module 415 determining that improved communication would have a higher impact on retaining a specific customer, action items may be generated and designed to improve communication. In an additional example, in response to attrition risk and recommendation module 415 determining that improved customer interaction would have a lower impact on retaining the specific customer, attrition risk and recommendation module 415 may not generate action items to improve customer interaction because it has a lower impact (e.g., relative to other factors) on retaining the customer.

In embodiments attrition risk and recommendation module 415 determines the attrition risk score, generates recommended action items, and/or ranks the recommended action items using a ML algorithms such a SHapley Additive exPlanations (SHAPE) algorithm and/or a Local Interpretable Model-agnostic Explanations (LIME) algorithm that are trained to identify which factors contribute the most to attrition risk using historical data. The SHAPE and LIME algorithms help interpret and explain complex models by providing insights into how individual features contribute to the attrition risk score. In this manner, SHAPE and LIME algorithms make the attrition risk score more understandable, transparent, and easier to determine actions to improve the attrition risk score.

In embodiments, attrition risk and recommendation module 415 is configured to perform a root cause analysis based on the customer score in response to determining that the customer score and/or the attrition risk score exceeds a predetermined threshold. In embodiments, attrition risk and recommendation module 415 performs a root cause analysis by systematically tracing back and analyzing the data points and factors that contributed to the customer score and/or the high attrition risk score. This process involves understanding the scoring model, identifying the input data, and determining the most significant contributing factors to the score. In this manner attrition risk and recommendation module 415 can efficiently trace back the data contributing to a high customer score or attrition risk score and provide actionable insights to address the root causes. In embodiments, attrition risk and recommendation module 415 generates a report that details the primary factors contributing to the customer score and the high attrition risk score, the relative impact of each factor, and any notable anomalies/outliers.

In embodiments, trend analysis and feedback module 420 is configured to perform frequent checkpointing to store a current customer state. As used herein, a customer state refers to the current status or condition of a customer as characterized by various metrics and attributes that describe their interactions, behaviors, preferences, and overall satisfaction. For example, the customer state may comprise a communications engagement score, platform interaction score, service adoption score, state/maturity of cloud environment, cloud spend/utilization, factors affecting customer satisfaction, sentiment score(s), weightage score(s), attrition risk score(s), and/or any other metric to measure a customer's overall satisfaction. In short, the current customer state captures a snapshot of the customer's satisfaction/dissatisfaction at a specific point in time. In embodiments, the frequency of the checkpointing may occur at a scheduled interval (e.g. hourly, daily, weekly, bi-weekly, monthly, etc.), or it may be triggered by a new action item. For example, in embodiments checkpointing may triggered by receiving a new action item. In other embodiments, the new action item may dictate a new interval for checkpointing, thereby triggering a checkpointing occurrence.

In embodiments, trend analysis and feedback module 420 is further configured to capture trends related to the customer based on the checkpointing that occurs over time. For example, in response to the customer becoming less of an attrition risk, changes occurring to the customer state in response to an action item, and/or any other event that changes the customer state occurring, trend analysis and feedback module 420 tracks this data and determines trends that may be fed back into the processes for determining recommended action items and/or ranking the recommended action items. Furthermore, this feedback data may also be fed back into the customer data as a historical recommendation (e.g., recommendations taken, customer response, etc.) to help determine future factors affecting satisfaction.

In embodiments, customer analytics and retention server 405 is further configured to gather customer states for multiple customers, including the customer content (i.e. customer data), factors affecting satisfaction, and the scores described herein for each of the multiple customers. In such embodiments, customer analytics and retention server 405 may generate clusters, groups and/or subgroups of customers that have similar pain points. As used herein, customer pain points are specific problems or issues that a customer experiences. Pain points are negative aspects that frustrate or dissatisfy customers, potentially leading to customer churn. Accordingly, customer analytics and retention server 405 may generate a first cluster for all customers that are unsatisfied with the cost of services and/or it may generate a second cluster for customers that are unsatisfied with the user interface.

In embodiments, customer analytics and retention server 405 is further configured to determine topic score(s) based on a level of impact of pain points within a cluster, group, and/or subgroup. For example, customer analytics and retention server 405 determines a issues or inabilities of a customer to adopt specific services that have a greater impact on customer churn than communication issues. In another example, customer analytics and retention server 405 may also (or alternatively) determine that the issues of the first cluster (i.e., customers that are unsatisfied with the cost of services) may be prioritized over the second cluster (i.e., customers that are unsatisfied with the user interface). Customer analytics and retention server 405 may use the prioritized cluster topics/issues to better determine the factors affecting customer satisfaction.

In embodiments, customer analytics and retention server 405 is further configured to rank cluster topics by an estimated business value based on recency of data (e.g., customer state, age of service, recency of communication), frequency of use (e.g., platform activity, logins, communications engagement, adoption of service offerings, adoption of recommendations), and/or monetary considerations (e.g., size of customer, revenue, contract value, etc.). In such embodiments, a higher rank means that the combination of data has a higher business value for a service provider, while a lower rank has a lesser business value for a service provider. In embodiments, the ranked cluster topics may be used to provide weighting for the factors affecting customer satisfaction.

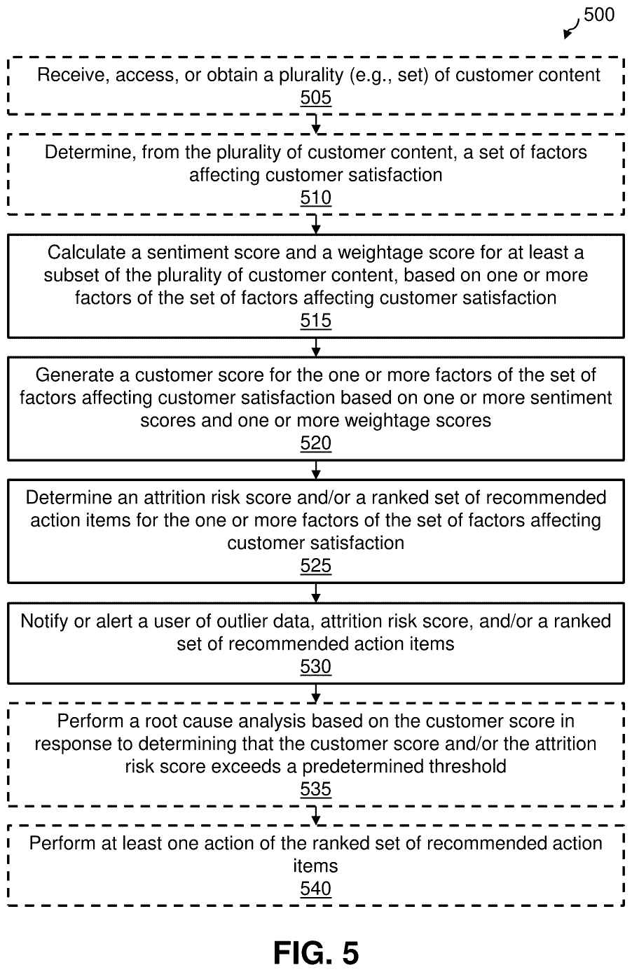

FIG. 5 shows a flowchart of an exemplary method 500 in accordance with aspects of the present invention. Steps of the method may be carried out in the environment of FIG. 4 and are described with reference to elements depicted in FIG. 4.

At step 505, customer analytics and retention server 405 of FIG. 4 optionally (as indicated by the dotted line) receives, accesses, or obtains a plurality (e.g., a set) of customer content. As explained above, customer content may include one or more of customer demographics (e.g., industry, region, size, revenue, new status, legacy status, age of service, and more), financial operations (FinOps) data (e.g., Cost/spend, budget, asset details, asset utilization metrics, maturity rating, and more), platform analytics data (e.g., bounce rate, login frequency, time spent on platform, cookies, interaction with competitors, and more), Azure development operations (DevOps) (e.g., bugs, feature requests, support tickets, and more), delivery statistics (e.g., delivery evaluations, customer feedback, meeting transcripts, meeting recordings, emails, written communications, cookies, interaction with competitors, and more), and historical recommendations (e.g., recommendations taken, customer response, and more). In embodiments, the customer content is received, accessed, or obtained from one or more instances of data source 430, knowledge base 435, and/or user device 440.

At step 510, scoring and outlier detection module 410 of FIG. 4 determines, from the plurality (e.g., set) of customer content, a set of factors affecting customer satisfaction. In other words, as noted above, scoring and outlier detection module 410 is configured to determine factors that affect customer satisfaction. In such embodiments, scoring and outlier detection module 410 inputs a summary of text (e.g., emails, meeting transcripts, service documentation, correspondence, and/or other records of communication with customers), tickets (e.g., service request tickets, feature request tickets, and/or bugs/issues reported), recordings, video, and/or other soft data into ML algorithm trained to generate a summarization of factors affecting customer satisfaction.

In embodiments, scoring and outlier detection module 410 may determine or select a specific ML algorithm or ML algorithms based on the customer content. For example, in embodiments, the ML algorithm(s) selected for summarizing textual data may include a generative AI algorithm (e.g., GPT 3.5) and/or a natural language processing algorithm (e.g., TextRank). If the customer content includes video data, the selected ML algorithm may further (or alternatively) include a transformer model (e.g., GPT-4®) or neural network algorithm (e.g., DeepMind® Perceiver) for summarizing video recordings and textual data. In embodiments having video and audio data, the selected model(s) may first transcribe the audio/video data to text and then summarize textual data, as described above.

At step 515, scoring and outlier detection module 410 of FIG. 4 calculates a sentiment score and a weightage score for at least a subset of the plurality (e.g., set) of customer content, based on one or more factors of the set of factors affecting customer satisfaction. In other words, in embodiments, scoring and outlier detection module 410 is configured to calculate a sentiment score and a weightage score for at least a subset of the plurality of customer content. As noted above, the sentiment score measures factors, including emotional tone or attitude expressed in customer feedback, reviews, or interactions and the weightage score measures the relative importance or influence of various factors contributing to a likelihood that a customer may stay.

At step 520, scoring and outlier detection module 410 of FIG. 4 generates a customer score for the one or more factors of the set of factors affecting customer satisfaction based on one or more sentiment scores and one or more weightage scores. In embodiments, the customer score is determined based, at least in part, on one or more sentiment scores and one or more weightage scores. In embodiments, the customer score may comprise one or more of a communications engagement score, platform interaction score, service adoption score, state and/or maturity of the cloud environment, cloud spend and utilization, and/or other scoring methods that measure a customer's level of satisfaction, level of engagement, and/or level of understanding of the services they are using.

At step 525, attrition risk and recommendation module 415 of FIG. 4 determines an attrition risk score and/or a ranked set of recommended action items for the one or more factors of the set of factors affecting customer satisfaction. In other words, attrition risk and recommendation module 415 is configured to receive one or more customer scores and the summarization(s) of factors affecting customer satisfaction (e.g., one or more sentiment scores and/or one or more weightage scores) from scoring and outlier detection module 410. Using the received customer scores combined with the summarization(s) of factors affecting customer satisfaction, attrition risk and recommendation module 415 determines and/or assigns an attrition risk score. As explained above, an attrition risk score measures the likelihood or probability that a customer will remain a customer or leave. Accordingly, the attrition risk score quantifies the risk of customer churn based on various factors affecting customer satisfaction and engagement.

In embodiments, attrition risk and recommendation module 415 is further configured to generate recommended action items for one or more of the factors affecting customer satisfaction. In embodiments, action items may be generated for each of the one or more of the factors affecting customer satisfaction. In other embodiments, action items may only be generated for any factor affecting customer satisfaction is associated with risk score that exceeds (or alternatively falls below) a predetermined threshold. In embodiments, attrition risk and recommendation module 415 is configured to rank the recommended action items based on the action's impact on customer satisfaction, including, the customer score and the summarization(s) of factors affecting customer satisfaction (e.g., one or more sentiment scores and/or one or more weightage scores). In other words, a higher ranked action item means that the action item has a greater impact on a customer's satisfaction as compared to a lower ranked action item that has a lesser impact on a customer's satisfaction. For example, if attrition risk and recommendation module 415 determines that improved communication would have a higher impact on retaining a specific customer, action items designed to improve communication would have a higher rank.

In embodiments attrition risk and recommendation module 415 determines the attrition risk score, generates recommended action items, and/or ranks the recommended action items using a ML algorithm such as a survival analysis algorithm (e.g., Cox Proportional Hazards model or XGBoost) trained to analyze and predict an amount of time until customer churn might occur. In embodiments, attrition risk and recommendation module 415 may additionally (or alternatively) use SHapley Additive exPlanations (SHAPE) algorithm and/or Local Interpretable Model-agnostic Explanations (LIME) algorithm to identify which factors contribute the most to attrition risk. The SHAPE and LIME algorithms help interpret and explain complex models by providing insights into how individual features contribute to the attrition risk score. In this manner, SHAPE and LIME algorithms make the attrition risk score more understandable, transparent, and easier to determine actions to improve the attrition risk score.

At step 530, customer analytics and retention server 405 of FIG. 4 notifies or alerts a user (e.g., user device 440 of FIG. 4) of a data outlier, attrition risk score, and/or a ranked set of recommended action items. In other words, in response to customer analytics and retention server 405 or one of the modules therein, detecting outlier data an attrition risk score, and/or a ranked set of recommended action items, customer analytics and retention server 405 may notify or alert a user of the new data, score, or action item. In embodiments, customer analytics and retention server 405 only notifies or alerts the user when the outlier data, attrition risk score, and/or the ranked set of recommended action items meets or exceeds a specific threshold.

At step 535, attrition risk and recommendation module 415 of FIG. 4 performs a root cause analysis based on the customer score in response to determining that the customer score and/or the attrition risk score exceeds a predetermined threshold. In embodiments, attrition risk and recommendation module 415 performs a root cause analysis by systematically tracing back and analyzing the data points and factors that contributed to the customer score and/or the high attrition risk score. The attrition risk and recommendation module 415 involves understanding the scoring model, identifying the input data, and determining the most significant contributing factors to the score. In embodiments, attrition risk and recommendation module 415 generates a report that details the primary factors contributing to the customer score and the high attrition risk score, the relative impact of each factor, and any notable anomalies/outliers.

At step 540, customer analytics and retention server 405 of FIG. 4 performs at least one action of the ranked set of recommended action items. As provided above, at least one action refers to specific, targeted interventions or strategies designed to address the factors affecting customer satisfaction. These action items aim to improve customer experience, reduce their risk of leaving, and enhance overall retention. For example, possible action items may include: retention strategies such as discounts, providing additional support, and/or creating tailored engagement plans; personalized offers such as tailored promotions and/or incentives based on the customer's preferences and behaviors, designed to increase their satisfaction and loyalty; service improvements such as changes or enhancements in service quality, responsiveness, and/or product features that address specific issues or concerns raised by customers; customer engagement initiatives such as activities to increase customer interaction and engagement; targeted communications such as tailored messages or outreach to address specific issues, provide solutions, and/or acknowledge customer feedback; etc. Accordingly, customer analytics and retention server 405 may be configured to automatically perform at least one action of the ranked set of recommended action items to improve customer experience, reduce their risk of leaving, and enhance overall retention.

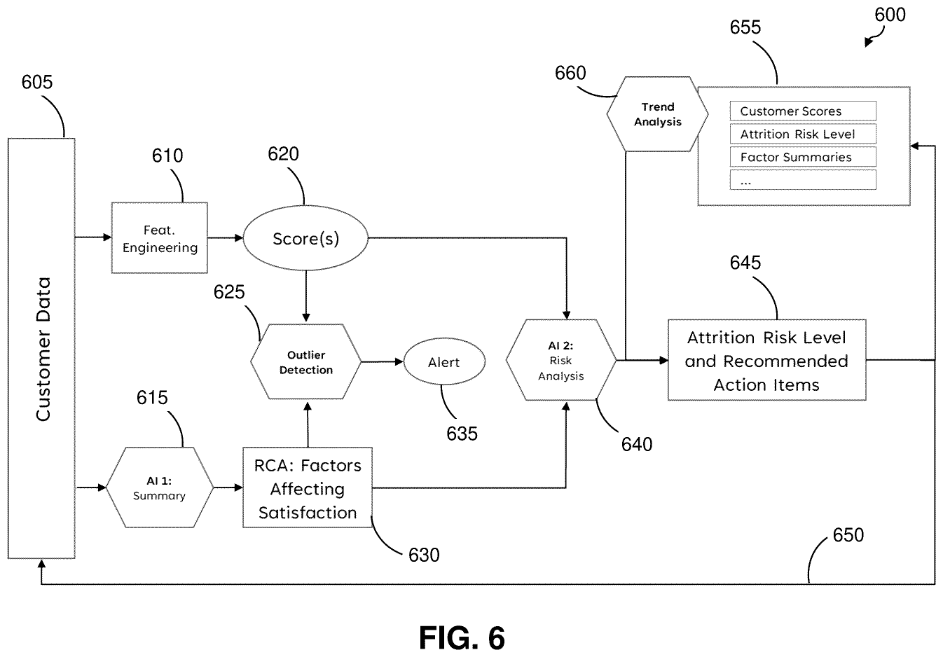

FIG. 6 shows an exemplary flow diagram 600 in accordance with aspects of the present invention. Steps of the method may be carried out in the environment of FIG. 4 and may include one or more steps, as described with respect to method 500 of FIG. 5. For example, customer data 605 is used as an input for feature engineering sub-module and is pre-processed by the system (e.g., customer analytics and retention server 405) before determining customer score(s) 620 which may comprise one or more of a communications engagement score, platform interaction score, service adoption score, state and/or maturity of the cloud environment, cloud spend and utilization, and/or other scoring methods that measure a customer's level of satisfaction, level of engagement, and/or level of understanding of the services they are using. In embodiments, the customer score may be determined using, for example, scoring and outlier detection module 410 of FIG. 4 in accordance with step 520 of FIG. 5.

As illustrated, customer data 605 is used as an input for AI 1 Summary 615 which determines the root cause analysis (RCA) factors affecting satisfaction 630 in accordance with steps 510 and 515 of FIG. 5. In embodiments, the ML algorithm(s) selected for summarizing textual data may include a generative AI algorithm (e.g., GPT 3.5) and/or a natural language processing algorithm (e.g., TextRank). If the customer content includes video data, the selected ML algorithm may further (or alternatively) include a transformer model (e.g., GPT-4®) or neural network algorithm (e.g., DeepMind® Perceiver) for summarizing video recordings and textual data. The systems, methods, and computer program product may use additional (or alternative) ML algorithms to summarize textual data and/or for summarizing video recordings. In embodiments having video and audio data, the selected model(s) may first transcribe the audio/video data to text and then summarize textual data, as described above.

In embodiments, the determined customer score(s) 620 and factors affecting satisfaction 630 may be used for outlier detection 625 by, for example, by scoring and outlier detection module 410 of FIG. 4. In other words, scoring and outlier detection module 410 may use statistical methods such as a z-score method, interquartile range, and/or any other statistical method for detecting outlier data to identify unusual negative or positive changes in sentiment and/or any of the factors that indicate a customer sentiment. When outlier data is detected, the system (e.g., customer analytics and retention server 405) may generate a notification and/or alert 635 based on the unusual negative or positive changes in sentiment and/or any of the factors that indicate a customer sentiment.

In embodiments, the determined customer score(s) 620 and factors affecting satisfaction 630 may be further used by AI 2: Risk Analysis 640 to determine attrition risk level and recommended action items 645 in accordance with step 525 of FIG. 5. In such embodiments, attrition risk and recommendation module 415 may employ a survival analysis algorithm (e.g., Cox Proportional Hazards model or XGBoost) trained to analyze and predict an amount of time until customer churn might occur. As used herein, a survival analysis algorithm refers to a ML algorithm that estimates the time until an event of interest occurs (e.g., churn) by using statistical models like the Cox proportional hazards model or the XGBoost model to calculate the probability of survival over time and the effect of variables on survival rate. In embodiments, attrition risk and recommendation module 415 may additionally (or alternatively) use a SHapley Additive exPlanations (SHAPE) algorithm and/or Local Interpretable Model-agnostic Explanations (LIME) algorithm to identify which factors contribute the most to attrition risk. The SHAPE and LIME algorithms help interpret and explain complex models by providing insights into how individual features contribute to the attrition risk score, making the attrition risk score more understandable, transparent, and it makes it easier to determine actions to improve the attrition risk score.

In aspects of the present invention, the attrition risk level and recommended action items 645 is used as a feedback loop 650 which is fed back to the customer data 605 as historical recommendations (e.g., recommendations taken, customer response, etc.). In such embodiments, the historical recommendations may be used to help determine factors affecting satisfaction in the future. The system (e.g., trend analysis and feedback module 420) may further use the attrition risk level and recommended action items 645 to perform frequent checkpointing to store a customer state 655. As noted above, the customer state 655 refers to the current status or condition of a customer as characterized by various metrics and attributes that describe their interactions, behaviors, preferences, and overall satisfaction. The system (e.g., trend analysis and feedback module 420) performs trend analysis 660 to capture trends related to the customer based on the checkpointing that occurs over time. For example, in response to the customer becoming less of an attrition risk, changes occurring to the customer state in response to an action item, and/or any other event that changes the customer state occurring, trend analysis and feedback module 420 tracks this data and determines trends that may be fed back into the processes for determining recommended action items and/or ranking the recommended action items. Furthermore, this feedback data may also be fed back into the customer data as historical recommendations (e.g., recommendations taken, customer response, etc.) to help determine factors affecting satisfaction in the future.

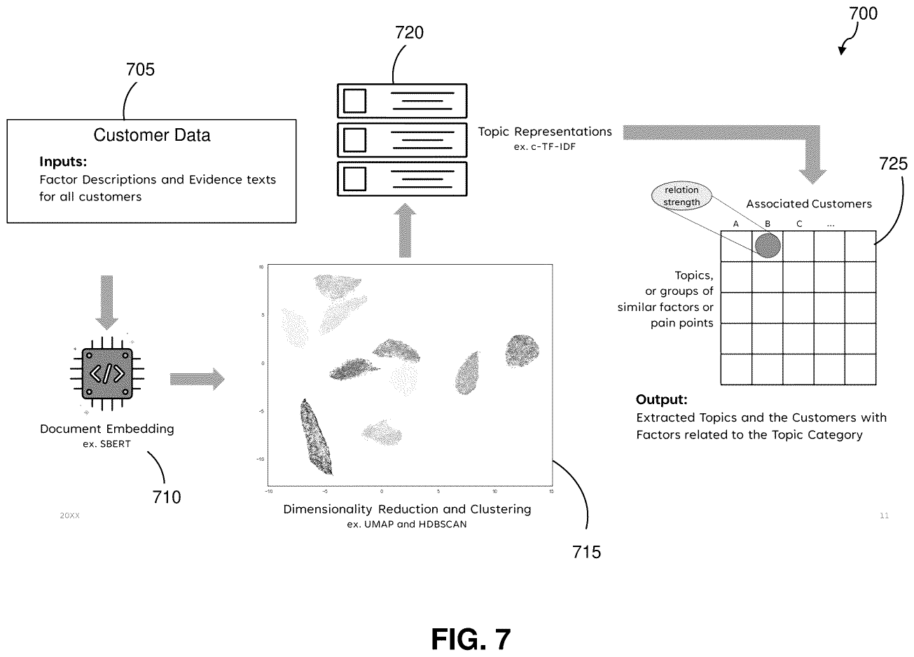

FIG. 7 shows exemplary flow diagram 700 in accordance with aspects of the present invention. Steps of the method may be carried out in the environment of FIG. 4 and are described with reference to elements depicted in FIG. 4 and may include one or more steps, as described with respect to method 500 of FIG. 5. For example, as noted above, customer analytics and retention server 405 may be configured to gather customer data 705 (e.g., customer content) for multiple customers. In embodiments customer data may comprise customer demographics (e.g., industry, region, size, revenue, new status, legacy status, age of service, and more), financial operations (FinOps) data (e.g., Cost/spend, budget, asset details, asset utilization metrics, maturity rating, and more), platform analytics data (e.g., bounce rate, login frequency, time spent on platform, cookies, interaction with competitors, and more), Azure development operations (DevOps) (e.g., bugs, feature requests, support tickets, and more), delivery statistics (e.g., delivery evaluations, customer feedback, meeting transcripts, meeting recordings, emails, written communications, cookies, interaction with competitors, and more), and historical recommendations (e.g., recommendations taken, customer response, and more).

Furthermore, evidence documents and/or summary of texts may be collected for the customer data 705 (e.g., customer content) and the documents may be used for document embedding 710. As used herein, document embedding 710 refers to the process of converting an entire document or text passage into a dense, fixed-size vector representation that captures its semantic meaning. This vectorized representation allows for efficient comparison, clustering, and retrieval of documents based on their content. These document embeddings are used to better understand and analyze the relationships and similarities between different documents. In embodiments, document embedding 710 may use a sentence bidirectional encoder representations from transformers (SBERT) model to generate sentence embeddings for semantic textual similarity tasks.

In embodiments, dimensionality reduction and clustering 715 receives the document embeddings 710 and reduces the dimensionality of the embeddings and clusters them. As used herein, dimensionality reduction is a method for reducing a number of input variables or features in a dataset while preserving as much of the original data's meaningful information as possible. This process helps simplify models, reduce computational costs, and mitigate issues like overfitting by removing redundant or irrelevant features. In embodiments, dimensionality reduction and clustering 715 may use a uniform manifold approximation and projection (UMAP) model to perform the dimensionality reduction. In such embodiments, attrition risk and recommendation module 415 of FIG. 4 uses a UMAP model by constructing a high-dimensional graph representing the data's manifold structure and then optimizing a lower-dimensional graph to closely resemble the original.

In embodiments, dimensionality reduction and clustering 715 further clusters the embeddings and/or the dimensionality reduced data and clusters the data. As used herein, clustering is a technique used to group similar data points together based on their features or attributes, without any prior labels or categories. The goal of clustering in the present invention is to identify underlying patterns or structures in the data, which can provide insights into its natural organization or help in discovering groups with similar characteristics, such as groups of customers that share common characteristics of pain points. By grouping similar data points together, the clustering performed by attrition risk and recommendation module 415 can reduce the complexity of the dataset, making it easier to summarize and visualize. In embodiments, attrition risk and recommendation module 415 may use a hierarchical density-based spatial clustering of applications with noise (HDBSCAN) model to cluster the embeddings and/or the dimensionality reduced data by building a hierarchical cluster tree and extracting the most stable clusters.

Topic representations 720 receives the clusters from dimensionality reduction and clustering 715 and generates topic representations describing the clusters. For example, attrition risk and recommendation module 415 may use a class-based term frequency-inverse document frequency (c-TF-IDF) model to analyze and understand the relevance of terms within the clusters. Using the class-based term frequency-inverse frequency model, attrition risk and recommendation module 415 aggregates the term frequency for all documents that belong to a particular cluster. Essentially, the class-based term frequency-inverse frequency model calculates the frequency of each term across all documents in a cluster, producing a cluster-level term frequency. The class-based term frequency-inverse frequency model is helpful to distinguish different clusters of documents. For example, in embodiments, this model identifies the most significant terms associated with each cluster.

In matrix 725, the customers and the topics or groups of similar factors (e.g., pain points) are plotted in the matrix to determine a relation strength between customers. In other words, the topics or groups of similar factors associated with the customers are compared to determine customers having the same (or similar) topics or groups of similar factors(e.g., pain points). Based on the matrix 725, customer analytics and retention server 405 determines the extracted topics and the customers with factors related to the topic category.

In such embodiments, customer analytics and retention server 405 may generate clusters, groups and/or subgroups of customers that have similar pain points. As used herein, customer pain points are specific problems or issues that a customer experiences. Pain points are the negative aspects that frustrate or dissatisfy customers, potentially leading to customer churn. Accordingly, customer analytics and retention server 405 may generate a first cluster for all customers that are unsatisfied with the cost of services and/or it may generate a second cluster for customers that are unsatisfied with the user interface.

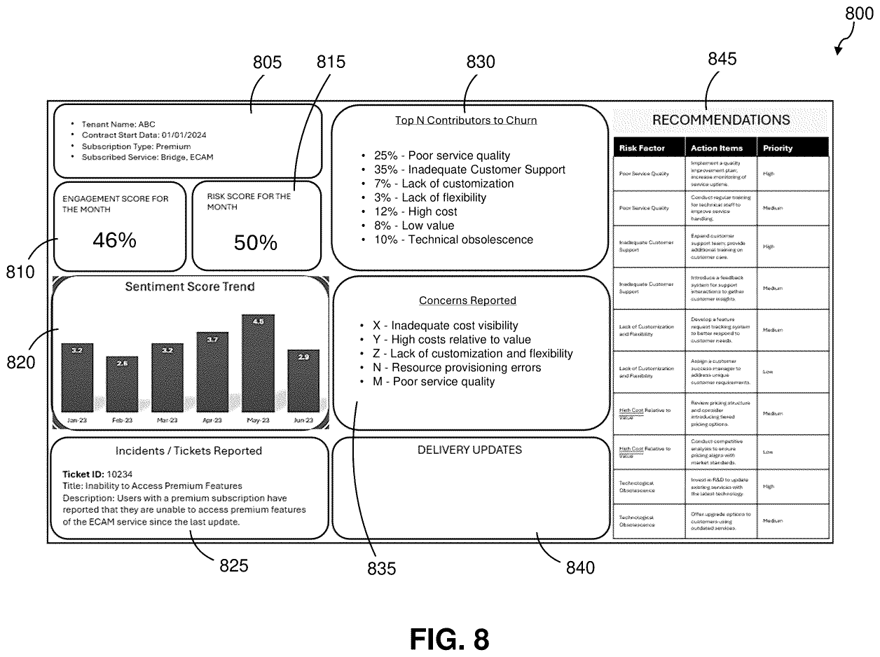

FIG. 8 shows exemplary dashboard 800 in accordance with aspects of the present invention. Steps of the method may be carried out in the environment of FIG. 4 and are described with reference to elements depicted in FIG. 4 and may include one or more steps, as described with respect to method 500 of FIG. 5 and method 600 of FIG. 6. For example, the customer content, data processing results, scores, trends, recommended actions, ranked lists, etc., in accordance with steps 505-540 of FIG. 5 may be transmitted and caused to be displayed at a user device (such as user device 440 of FIG. 4). As illustrated, in embodiments, dashboard 800 may include customer data (e.g., content) module 805 which may display, for example, the customer's name, start data of service, subscription type, and specific services that the customer subscribes to.

In embodiments, dashboard 800 may further display the customer's engagement score for the month 810, which measures the customer's engagement with the services offered. Dashboard 800 may further display the customer's risk score for the month 815, which measures the customer's likelihood of leaving a service and/or all services offered by the service provider. In embodiments, engagement score for the month 810 and/or risk score for the month 815 may comprise at least one of a number, a percentage, a grade, a graphic, and/or any other method for providing a quantitative or a qualitative score.

In embodiments, dashboard 800 may further display the customer's sentiment score trend 820, which tracks the changes to a customer's sentiment score based on the customer's interactions with the services and with the service provider. In embodiments, incidents/tickets reported 825 may be displayed to highlight, alert, or raise awareness regarding the customer's most recent incidents and/or service tickets, including, for example, a ticket highlighting the customer's inability to access premium features.

In embodiments, dashboard 800 may further display top n contributors to churn 830 which provides the top factors that lead similar customers to leave a service. In embodiments, only a description of the factor may be displayed. In other embodiments a description of the factor may be displayed with at least one of a number, a percentage, a grade, a graphic, and/or any other method for providing a quantitative or a qualitative score. In embodiments, the displayed top n contributors to churn 830 are specific to the customer based on the customer's content and data. In other embodiments, the displayed top n contributors to churn 830 describe data collected and analyzed for companies having similar topics and factors, in accordance with the description of FIG. 7.

In embodiments, dashboard 800 may further display concerns reported 835, which provides a list of concerns that have been reported, mentioned, or otherwise documented in the customer content (e.g., collected in accordance with steps 505 and 510 of FIG. 5). In embodiments, dashboard 800 may further display delivery updates 840, which may include scheduled action items that have been or will be delivered to the client.

In embodiments, dashboard 800 may further display recommendations 845 (e.g., determined in accordance with steps 520-525 of FIG. 5). In embodiments, the recommendations 845 may be displayed by listing a risk factor, an action item associated with the risk factor, and a priority level related to the risk factor and/or the action item associated with the risk factor. In embodiments the priority level may comprise at least one of a number, a percentage, a grade, a graphic, and/or any other method for providing a quantitative or a qualitative score.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer system/server 12 (FIG. 1), can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, a plurality of customer content;
calculating, by the processor set using a first machine learning algorithm, a sentiment score and a weightage score for at least a subset of the plurality of customer content;
generating, by the processor set using a second machine learning algorithm, a customer score for one or more factors of a set of factors affecting customer satisfaction based on the sentiment score and the weightage score for at least the subset of the plurality of customer content;
determining, by the processor set using a third machine learning algorithm, an attrition risk score and a first ranked set of recommended action items for the one or more factors of the set of factors affecting customer satisfaction;
notifying a user of the attrition risk score and the first ranked set of recommended action items to be executed; and
performing, by the processor, a first action of the first ranked set of recommended action items.

2. The computer-implemented method of claim 1, further comprising generating a current customer state and the first ranked set of recommended action items to be executed in response to a triggering event.

3. The computer-implemented method of claim 2, wherein the triggering event comprises an execution of at least one action item of the first ranked set of recommended action.

4. The computer-implemented method of claim 1, wherein the attrition risk score and the first ranked set of recommended action items are determined based on a combination of the plurality of customer content, the sentiment scores, and the weightage scores.

5. The computer-implemented method of claim 1, wherein the plurality of customer content comprises customer communications, demographics data, platform analytics, and historical recommendations.

6. The computer-implemented method of claim 1, further comprising:
performing a root cause analysis in response to the attrition risk score exceeding a threshold; and
recommending a second ranked set of recommended action items based on the root cause analysis.

7. The computer-implemented method of claim 1, further comprising receiving feedback data and second data inputs related to an entity based on a customer response to the first ranked set of recommendation actions items.

8. The computer-implemented method of claim 1, wherein the first action of the first ranked set of recommended action items comprises a highest ranking action.

9. A computer program product comprising one or more computer readable storage media having program instructions collectively stored on the one or more computer readable storage media, the program instructions executable to:
receive a plurality of customer content;
calculate, using a first machine learning algorithm, a sentiment score and a weightage score for at least a subset of the plurality of customer content;
generate, using a second machine learning algorithm, a customer score for one or more factors of a set of factors affecting customer satisfaction based on the sentiment score and the weightage score for at least the subset of the plurality of customer content;
determine, using a third machine learning algorithm, an attrition risk score and a first ranked set of recommended action items for the one or more factors of the set of factors affecting customer satisfaction;
notify a user of the attrition risk score and the first ranked set of recommended action items to be executed; and
perform a first action of the first ranked set of recommended action items.

10. The computer program product of claim 9, wherein the program instructions are further executable to generate a current customer state and the first ranked set of recommended action items to be executed in response to a triggering event.

11. The computer program product of claim 10, wherein the triggering event comprises an execution of at least one action item of the first ranked set of recommended action.

12. The computer program product of claim 9, wherein the attrition risk score and the first ranked set of recommended action items are determined based on a combination of the plurality of customer content, the sentiment scores, and the weightage scores.

13. The computer program product of claim 9, wherein the plurality of customer content comprises customer communications, demographics data, platform analytics, and historical recommendations.

14. The computer program product of claim 9, wherein the program instructions are further executable to:
perform a root cause analysis in response to the attrition risk score exceeding a threshold; and
recommend a second ranked set of recommended action items based on the root cause analysis.

15. The computer program product of claim 9, wherein the program instructions are further executable to receive feedback data and second data inputs related to an entity based on a customer response to the first ranked set of recommendation actions items.

16. A system comprising:
a processor, a computer readable memory, one or more computer readable storage media, and program instructions collectively stored on the one or more computer readable storage media, the program instructions executable to:
receive a plurality of customer content;
calculate, using a first machine learning algorithm, a sentiment score and a weightage score for at least a subset of the plurality of customer content;
generate, using a second machine learning algorithm, a customer score for one or more factors of a set of factors affecting customer satisfaction based on the sentiment score and the weightage score for at least the subset of the plurality of customer content;
determine, using a third machine learning algorithm, an attrition risk score and a first ranked set of recommended action items for the one or more factors of the set of factors affecting customer satisfaction;
notify a user of the attrition risk score and the first ranked set of recommended action items to be executed; and
perform a first action of the first ranked set of recommended action items.

17. The system of claim 16, wherein the program instructions are further executable to generate a current customer state and the first ranked set of recommended action items be executed in response to a triggering event, and
wherein the triggering event comprises an execution of at least one action item of the first ranked set of recommended action.

18. The system of claim 16, wherein the attrition risk score and the first ranked set of recommended action items are determined based on a combination of the plurality of customer content, the sentiment scores, and the weightage scores.

19. The system of claim 16, wherein the program instructions are further executable to:
perform a root cause analysis in response to the attrition risk score exceeding a threshold; and
recommend a second ranked set of recommended action items based on the root cause analysis.

20. The system of claim 16, wherein the program instructions are further executable to receive feedback data and second data inputs related to an entity based on a customer response to the first ranked set of recommendation actions items.
